(19) United States
(12) Patent Application Publication
(10) Pub. No.: US 2010/0005377 A1
(43) Pub. Date: Jan. 7, 2010

(54) SYSTEM AND METHOD FOR CUSTOMIZING MULTIMEDIA ENHANCED ITEMS

(76) Inventor: Shalom BATAN, Karmiel (IL)

Correspondence Address: William H. Dippert;Eckert Seamans Cherin & Mellott, LLC, U.S. Steel Tower, 600 Grant Street, 44th Floor, Pittsburgh, PA, 15219, US

(21) Appl. No.: 12/496,393

(22) Filed: Jul. 1, 2009

Related U.S. Application Data
(60) Provisional application No. 61/077,546, filed on Jul. 2, 2008.

(51) Int. Cl. G06F 17/00; G06F 3/048; G06F 15/16

(52) U.S. Cl. 715/201; 715/764; 709/203

(57) ABSTRACT

The present invention describes a multimedia enhanced gift item, an external customization unit and a computer implemented method for enabling a user to customize multimedia enhanced gift items. Such an item can facilitate combining personal greetings to a greeting card, to a stuffed animal, and to other toys or objects alike. A user buying multimedia enhanced gift item may use the method to provide and generate multimedia contents to be embedded in that item, and wherein the multimedia contents can be played on demand at any time later.

The present invention is based upon and claims priority of Provisional Patent Application Ser. No. 61/077,546, filed Jul. 2, 2008, the contents of which are incorporated herein in their entirety.

### FIELD OF THE INVENTION

The present invention generally relates to the field of computer implemented systems, and methods. More particularly, the present invention relates to a computer implemented system and method for customizing audio and video enhanced items.

### BACKGROUND OF THE INVENTION

Known multimedia enhanced items, such as greeting cards, generally have predefined multimedia content typically a retrievably stored audio file. Sometimes audio or video enhancements may be selected from predefined catalogues of audio or movies streams.

A user buying a greeting card or other similar item may want to have personal content embedded in the enhanced item, which the recipient may access at a time of their choosing.

Current solutions which are available for providing personal greeting cards include e-cards that are sent by e-mail to the electronic mail box of the receiver. Audio enhanced greeting cards such as the greeting card described in US Patent Application Publication No. 2007/0171278 titled “Multimedia Greeting Card” to Tony Chen. Chen's greeting card has a playback button allowing a recipient to play back a pre-stored audio file; however, Chen does not provide a method for customizing the card. Furthermore, only enhanced greeting cards are described. It is noted that greeting cards are only one of a number of greetings gifts. Other common gifts passed between well-wishers include stuffed animals, toiletries and the like.

There is a need, therefore for customizable multimedia enabled gift items and an appropriate customization system. Embodiments of the current invention address this need.

### SUMMARY OF THE INVENTION

In accordance with a first embodiment, the present invention is directed to providing multimedia enhanced gift item comprises at least one data storage unit for storing computer operable code and multimedia files, at least one processor for running said computer operable code directed to output said multimedia files, at least one data output unit for presenting said output multimedia files, and at least one input interface for receiving said multimedia files from an external customization unit.

Preferably, the data output units are selected from a group consisting of audio device, image display and video display unit.

Optionally, the multimedia enhanced gift item further comprising a power switch operated by means selected from a group consisting of: magnetic means, electro magnet means timed means and manual means. Optionally, the input interface is selected from a group consisting of: USB ports, Bluetooth transceivers, wireless transceivers, and Ethernet means.

In various embodiments a printed circuit board comprising said data storage unit, said processor and said input interface for use in said multimedia enhanced gift item.

In various embodiments the multimedia enhanced gift item is embedded in an item made out of material selected from the group consisting of: cardboard, stiff textile and paper.

In various embodiments the multimedia enhanced gift item is selected from a group consisting of: greeting cards, toys, decorative items, cushions, novelty items and pictures.

Optionally, the multimedia enhanced gift item further comprising an external customization unit for customizing said multimedia enhanced gift item.

In various embodiments the multimedia enhanced gift item further comprises an external customization unit for wherein said external customization unit comprising a database for storing a catalogue comprising a plurality of multimedia files, and an output interface unit for communicating with said input interface unit.

Preferably, the external customization unit further comprises a processor for processing operable code directed to customizing said multimedia files.

Optionally, the external customization unit further comprises a user interface for allowing a user to select and edit said multimedia files.

In various embodiments, the external customization unit is further being connected to a computer network. Optionally, said multimedia files are stored on said network. Optionally, said multimedia files are acquired from a camera or a video camera.

Optionally, the operable code is directed towards manipulating and changing of raw multimedia files and generating said playable multimedia files. Optionally, the operable code is directed towards transmitting and storing data to said data storage unit of said gift item via said input interface. Optionally, the operable code is stored on said data storage unit of said gift item and is activated when said gift item communicates with said external customization.

It is according to still a further embodiment of the invention to teach a method for customizing multimedia enhanced gift item with at least one customized playable multimedia files to be played on multimedia enhanced gift item, said computer implemented method comprising the steps:

Step (a)—Initializing customization step, wherein said multimedia enhanced gift item is configured and set to communicate with said computer;

Step (b)—generating said customized playable multimedia file;

Step (c)—directing said operable code to store said customized playable multimedia file in said data storage of said multimedia enhanced gift item, and

Step (d)—disconnecting said communication means of said multimedia enhanced gift item from said computer.

Alternatively, step (b) of generating said customized playable multimedia file comprises the substep:

Step (b1)—selecting at least one multimedia file from said plurality of customized playable multimedia files

Optionally, Step (b) of generating said customized playable multimedia file comprises the substeps:

Step (b2)—selecting at least one file from a plurality of raw multimedia files, and

Step (b3)—directing operable code to manipulate the selected multimedia files thereby generating said customized playable multimedia file.

Optionally, the external customization unit communicates with the multimedia enhanced gift item by connecting a USB cable.

### BRIEF DESCRIPTION OF THE FIGURES

Some embodiments of the invention are herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### In the Drawings:

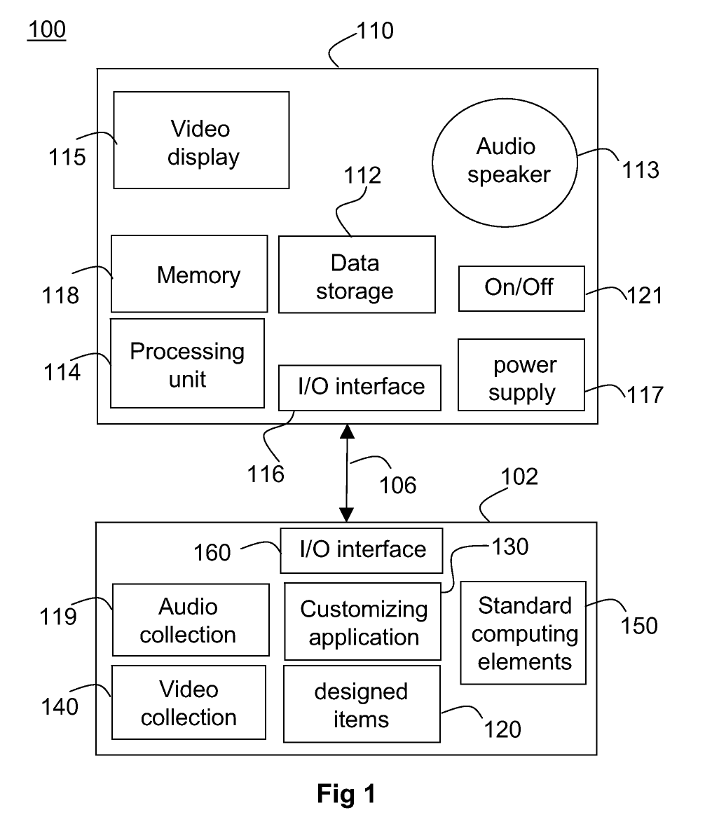

FIG. 1 illustrates a system 100 for customizing enhanced cards with audio and video contents, according with one embodiment of the present invention.

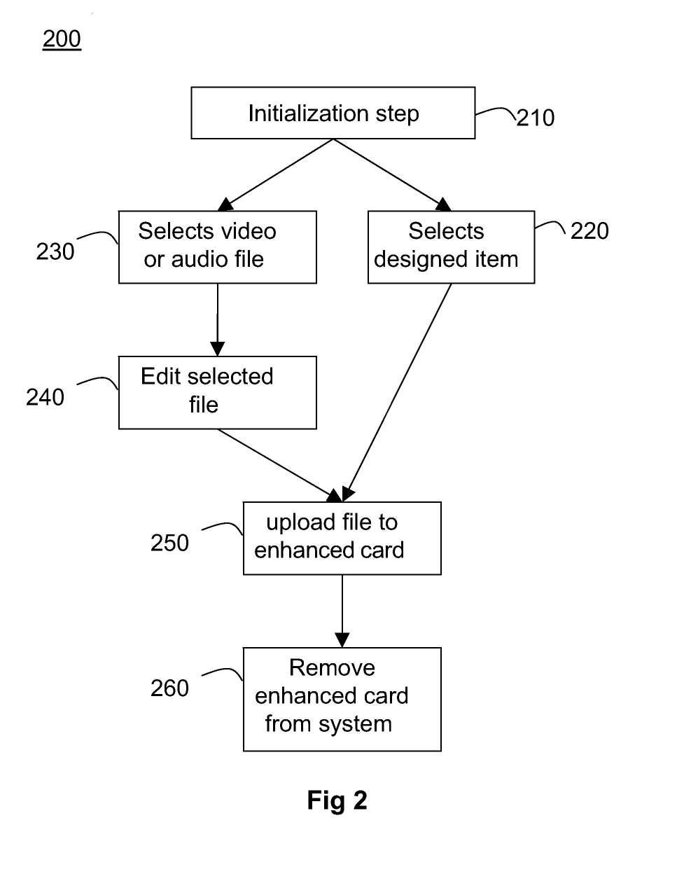

FIG. 2 illustrates a flowchart 200 of a computer implemented method for enabling a user to customize an audio and a video enhanced card, according to some embodiments of the invention.

### DETAILED DESCRIPTION OF THE INVENTION AND FIGURES

Before explaining at least one embodiment of the invention in detail, it is to be understood that the invention is not necessarily limited in its application to the details set forth in the following description or exemplified by the examples. The invention is capable of other embodiments or of being practiced or carried out in various ways.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

The present invention discloses a system and methods for customizing the video and audio content of an audio and video enhanced item. The present invention also discloses a new enhanced card capable of presenting customized audio and video content. The presented enhanced card may be embedded in different items, such as stuffed toys, greeting cards etc.

Reference is now made to FIG. 1 illustrating a multimedia enhancement system 100 for greetings gifts according to a first embodiment of the invention. Specifically, by way of example only, a system 100 is shown for customizing a greeting card 110. It will be appreciated that such a system may be used in conjunction with other greetings gifts such as postcards, toys, cushions and the like.

The multimedia enhancement system 100 includes a multimedia greeting card 110 and a separate customization unit 102. It is a particular feature of embodiments of the invention that a communication channel 106 is provided between the greeting card 110 and the customization unit 102 for transferring multimedia data, such as audio files, video files and the like for display via a data output 113, 115.

According to certain embodiments of the invention, the customization unit 102 may be a computing device, accessible by a user (not shown in the figure), such as a computer running a dedicated software application. Alternatively, a dedicated base unit may be provided for customizing the multimedia card 110. For example, a vending machine may provide customization for cards supplied thereby or a vendor may provide a customization service for purchasers of multimedia cards. Other customization units 102 may be preferred where appropriate. Preferably, the customization unit 102 may be connected to the World Wide Web such that online media files may be readily available.

Typically, the enhanced multimedia card 110, includes a power source 117, a data storage unit 112, a processor 114, a memory 118, at least one data output 113, 115, and an input interface 116. Preferably, the card 110 also includes a power switch 119.

The data storage unit 112 is provided for storing computer operable code including software applications and multimedia data such as video and audio files. Multimedia data may be saved to the storage unit 112 via the communication channel 106 and the input interface 116. The processing unit 114 is provided for running operable code directed to processing the multimedia files thereby sending audio signals to an audio speaker 113 and video frames to a video display 115. The memory 118 may provided for executing the programs stored in storage 112.

The input interface 116 is configured to communicate with external devices, such as the customization unit 102 and may further communicate with other devices such as telephones, media storage devices, computers cameras or the like, for acquiring audio and video data as well as programs. The power supply 117 such as a battery, a super capacitor or the like may be controlled by a power switch 119 for activating and deactivating the viewing and listening of content stored on the card, other user controls such as play, rewind, fast forward, skip and pause controls may be further provided where required.

The Enhanced card 110 is typically operable to communicate with the customization unit 102 for storing audio and video segments in storage 112. Optionally, the enhanced card 110 is capable of presenting audio and video data, on demand, via speaker 113 and video display 115. Operation of enhanced card 110 may be enabled via power supply 117 or alternatively via a power cable, or alternatively via a USB connection to the customization unit 102.

Optionally, the enhanced card 110 is a PCB that is capable of being mounted on a card board, carton, stiff textile, etc.

Optionally, the enhanced card 110 is made of a USB mass storage enhanced with video display that is capable of being mounted on a card board, carton, stiff textile, etc.

Optionally, the On/Off switch 121 can be operated by a magnet, or by an electro magnet, or manually, e.g., by pressing a button, or by separating the two magnets or the electro magnets—when opening the card board. Whereas when the state of the switch is changed, the switch is capable of sensing the change and then initiates the processing on the enhanced card (start executing application for playing audio and video data stored at known location in data storage 112).

Optionally, the enhanced card is embedded in a verity of products such a greeting card, a toy, a decoration element etc.

The customization unit 102 may be any computing device on which a user can run a program for preparing audio and video segments as known in the art. The customization unit 102 should preferably be capable of transmitting audio and video data to an external device by some of the known means such as USB cable, wireless, Bluetooth, or Ethernet that are represented by a line 106.

The customization unit 102 schematically presented in FIG. 1 for illustrating a system for enabling a user to customize audio and video enhanced cards according to some embodiment of the invention. The customization unit 102 comprises an audio collection 119 comprising plurality of audio files; a video collection 140 comprising plurality of video files that provide raw materials to be used for generating audio and video streams ready to be used by enhanced card 110; designed items 120 comprising plurality of multimedia data files prepared to be played on a remote device, such as by enhanced card 110; customizing application 130 for preparing designed items 120 from raw material in audio collection 119 and in video collection 140; an I/O interface 160 for communicating with enhanced card 110; and standard computing elements 150 as found in a regular computing device for executing customizing application 130.

Customizing application 130 is used for editing, managing and manipulating user choices of multimedia data with user acquired audio and video data, in order to generate audio and video data for executing by enhanced card 110. With customizing application program 130 the user can choose preferred audio and video files from audio collection 119 and video collection 140, or the user can bring such files from other external devices such as a camera or the internet and edit them to fit his/her preferences.

Alternatively, the user can use customizing application 130 to get playable multimedia files, form designed items 120, that are already prepared and in the proper format, and transmit them to a remote device for playing on demand.

Customizing application 130 is used to upload the files that are in the proper format to enhanced card 110 via connection 106.

Optionally, customizing application 130 is stored in data storage 112 thus a user must only buy a non-customized enhanced card 110, plug it to his/her computer via connection 106 and start the customization process without the need to separately install customizing application 130.

Optionally, audio collection 119 is a shared audio data in a site on the internet.

Optionally, video collection 140 is a shared video data in a site on the internet.

Reference is now made to FIG. 2 illustrating a flowchart 200 of a computer implemented method for enabling a user to customize an audio and video enhanced card, according to some embodiments of the invention. The computer implemented method comprises the stages:

(Stage 210) Initialization step. Two alternatives are presented:
a. A user starts the customizing application 130 on computing device 102 for preparing designed item and then connect enhanced card 110 via connection 106.
b. A user connects enhanced card 110 to computing device 102 via connection 106 and then starts application 130 on computing device 102.
c. It will be appreciated that the enhanced card may be connected to the computing device either by a wired or wireless connection such as Bluetooth, Wi-Fi or the like.
   (Stage 220) Choosing an already prepared audio or video file from designed items 120.
   (Stage 230) Choosing an audio file from audio collection 119 or a video file from video collection 140 in response to the user choice.
   (Stage 240) Applying editing options of customized application 130 to the selected file, for generating customized content in response to the user choices.
   (Stage 250) Uploading the selected file to the enhanced card 110 via connection 106. The enhanced card 110 is customized and ready for use.
   (Stage 260) Removing the card and using it to play and view the customized content.

According to some embodiments of the present invention, the customizable items may be greeting cards, dolls, toys, any designed gift and the like.

According to some embodiments of the present invention, further level of customization may be achieved by enabling the user to individually provide personal text such as dedication upon the customizable item.

Although various features of the invention may be described in the context of a single embodiment, the features may also be provided separately or in any suitable combination. Conversely, although the invention may be described herein in the context of separate embodiments for clarity, the invention may also be implemented in a single embodiment

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

What is claimed is:

1. A multimedia enhanced gift item comprising:
at least one data storage unit for storing computer operable code and multimedia files;
at least one processor for running said computer operable code directed to output said multimedia files;
at least one data output unit for presenting said output multimedia files, and
at least one input interface for receiving said multimedia files from an external customization unit.

2. The multimedia enhanced gift item of claim 1, wherein said data output units are selected from a group consisting of audio device, image display and video display unit.

3. The multimedia enhanced gift item of claim 1, further comprising a power switch operated by means selected from a group consisting of: magnetic means, electro magnet means timed means and manual means.

4. The multimedia enhanced gift item of claim 1, wherein said input interface is selected from a group consisting of: USB ports, Bluetooth transceivers, wireless transceivers, and Ethernet means.

5. A printed circuit board comprising said data storage unit, said processor and said input interface for use in said multimedia enhanced gift item of claim 1.

6. The multimedia enhanced gift item of claim 1, wherein said enhanced gift item is embedded in an item made out of material selected from the group consisting of: cardboard, stiff textile and paper.

7. The multimedia enhanced gift item of claim 1, wherein said enhanced gift item is selected from a group consisting of: greeting cards, toys, decorative items, cushions, novelty items and pictures.

8. The multimedia enhanced gift item of claim 1, further comprising an external customization unit.

9. An external customization unit for use with said multimedia enhanced gift item of claim 1, wherein said external customization unit comprising a database for storing a catalogue comprising a plurality of multimedia files, and an output interface unit for communicating with said input interface unit.

10. The external customization unit of claim 9 further comprising a processor for processing operable code directed to customizing said multimedia files.

11. The external customization unit of claim 9 further comprising a user interface for allowing a user to select and edit said multimedia files.

12. The external customization unit of claim 9 further being connected to a computer network.

13. The external customization unit of claim 12, wherein said multimedia files are stored on said network.

14. The external customization unit of claim 9, wherein said multimedia files are acquired from a camera or a video camera.

15. The external customization unit of claim 10, wherein said operable code is directed towards manipulating and changing of raw multimedia files and generating said playable multimedia files.

16. The external customization unit of claim 10, wherein said operable code is directed towards transmitting and storing data to said data storage unit of said gift item via said input interface.

17. The external customization unit of claim 10, wherein said operable code is stored on said data storage unit of said gift item and is activated when said gift item communicates with said external customization.

18. A computer implemented method for customizing multimedia enhanced gift item with at least one customized playable multimedia files to be played on multimedia enhanced gift item, said computer implemented method comprising the steps:
initializing customization, wherein said multimedia enhanced gift item is configured and set to communicate with said computer;
generating said customized playable multimedia file;
directing said operable code to store said customized playable multimedia file in said data storage of said multimedia enhanced gift item; and
disconnecting said communication means of said multimedia enhanced gift item from said computer.

19. The method of claim 18, wherein step (b) of generating said customized playable multimedia file comprises the substep:
selecting at least one multimedia file from said plurality of customized playable multimedia files.

20. The method of claim 18, wherein step (b) of generating said customized playable multimedia file comprises the substeps:
selecting at least one file from a plurality of raw multimedia files, and
directing operable code to manipulate the selected multimedia files thereby generating said customized playable multimedia file.

21. The computer implemented method of claim 18, wherein step (a) of initializing customization comprises connecting a USB cable between said computer and said enhanced gift item.
